(19) United States
(12) Patent Application Publication
(10) Pub. No.: US 2017/0249559 A1
(43) Pub. Date: Aug. 31, 2017

(54) APPARATUS AND METHOD FOR ENSEMBLES OF KERNEL REGRESSION MODELS

(71) Applicant: GE Intelligent Platforms, Inc., Charlottesville, VA (US)

(72) Inventor: James P. HERZOG, Lisle, IL (US)

(21) Appl. No.: 15/510,418

(22) PCT Filed: Mar. 4, 2015
(86) PCT No.: PCT/US15/18698

§ 371 Date: Mar. 10, 2017

Related U.S. Application Data
(60) Provisional application No. 62/049,558, filed on Sep. 12, 2014.

(51) Int. Cl. G06N 7/00; G06N 5/04

(52) U.S. Cl. CPC G06N 7/005; G06N 5/048

(57) ABSTRACT

Information representing physical parameters associated with the entity or process is sensed. The sensed information is collected into a current pattern or into a current sequence of patterns. The current pattern or current sequence of patterns is compared to historical data in order to obtain a population of best matches. A plurality of kernel regression models is created based upon the population of best matches. At least one distribution of estimate values is generated for a sensor of interest using the plurality of kernel regression models. The at least one distribution of the estimate values is analyzed for a sensor of interest to obtain a measure of the center of the at least one estimate distribution and a measure of the width of the at least one estimate distribution.

### CROSS REFERENCE TO RELATED APPLICATION

This application claims the benefit under 35 U.S.C. §119 (e) to U.S. Provisional Application No. 62/049558 entitled APPARATUS AND METHOD FOR ENSEMBLES OF KERNEL REGRESSION MODELS, filed Sep. 12, 2014, the content of which is incorporated herein by reference in its entirety.

### BACKGROUND OF THE INVENTION

Field of the Invention

This application relates to modeling and, more specifically, obtaining estimates of behavior of parameters based upon modeling.

Brief Description of the Related Art

Kernel regression is a form of modeling used to determine a non-linear function or relationship between values in a dataset and is used to monitor machines or systems to determine the condition of the machine or system. For Sequential Similarity Based Modeling (SSM), multiple sensor signals measure physically correlated parameters of a machine, system, or other object being monitored to provide sensor data. The parameter data may include the actual or current values from the signals or other calculated data whether or not based on the sensor signals. The parameter data is then processed by an empirical model to provide estimates of those values. The estimates are then compared to the actual or current values to determine if a fault exists in the system being monitored.

More specifically, the model generates the estimates using a reference library of selected historic patterns of sensor values representative of known operational states. These patterns are also referred to as vectors, snapshots, or observations, and include values from multiple sensors or other input data that indicate the condition of the machine being monitored at an instant in time. In the case of the reference vectors from the reference library, the vectors usually indicate normal operation of the machine being monitored. The model compares the vector from the current time to a number of selected learned vectors from known states of the reference library to estimate the current state of the system. Generally speaking, the current vector is compared to a matrix made of selected vectors from the reference library to form a weight vector. In a further step, the weight vector is multiplied by the matrix to calculate a vector of estimate values. The estimate vector is then compared to the current vector. If the estimate and actual values in the vectors are not sufficiently similar, this may indicate a fault exists in the object being monitored.

Another form of kernel regression modeling is Variable Similarity Based Modeling (VBM). In VBM, reference data observations are first acquired from the sensors or measurements representative of the machine, process or system. Then, the model is computed from a combination of the representative data with a current observation from the same sensors or measurements. The model is recomputed with each new observation of the modeled system. The output of the model is an estimate of at least one sensor, measurement or other classification or qualification parameter that characterizes the state of the modeled system.

Although the above-mentioned approaches can be utilized to obtain estimates, there are some limitations with obtaining estimates in this way. There are problems in some industries in which regression models are used to estimate the response of a key sensor or operational parameter that is not measured for significant periods of time or can't be measured at all, since the future response is being estimated. Accurate calculation of confidence bounds is especially beneficial for these problems, since the estimate and associated confidence bounds would be the only data available for the key parameter.

One example of an industry problems mentioned above concerns pump-assisted oil and gas extraction. Down hole sensors in wells and on electrical-submersible pumps provide continuous measurements of parameters such as reservoir temperature, reservoir pressure, and pump speed, but none of the key well performance parameters used to determine the volume of oil and gas extracted. Key performance parameters such as volumetric flow rate and water-cut (i.e., the ratio of water produced compared to the volume of total liquids produced from an oil well) are measured at irregular intervals during well tests. Consequently, current approaches do not do an adequate or acceptable job at obtaining these types of estimates.

These problems have created some general user dissatisfaction with previous approaches.

### BRIEF DESCRIPTION OF THE INVENTION

The present approaches create an ensemble (family) of kernel regression models for each observation vector of sensor data received from an object or process being monitored. The models in the ensemble are created from data that are similar to the current conditions, but are independent of one another. Each of the models generates an estimate vector for each of the model variables. Statistics are calculated from the distribution of estimates generated for each variable. In one aspect, the mean of the estimate distribution is calculated and this provides a more robust estimate of the current conditions than that produced by any single model. In another aspect, the median of the distribution is calculated. Since the population of independent models is correlated with sensor and process error, measures of the width of the estimate distribution (for instance, standard deviation) provide an indication of the uncertainty of model estimates for the current observation vector.

In many of these embodiments, information representing physical parameters associated with the entity or process is sensed. The sensed information is collected into a current pattern or into a current sequence of patterns. The current pattern or current sequence of patterns is compared to historical data in order to obtain a population of best matches. A plurality of kernel regression models is created based upon the population of best matches. At least one distribution of estimate values is generated for at least one sensor of interest using the plurality of kernel regression models. The distribution of the estimate values is analyzed for one or more sensors of interest to obtain a measure of the center of the estimate distribution and a measure of the width of the estimate distribution, for each of the sensors of interest.

In some aspects, the creating comprises creating the plurality of kernel regression models at a single and current point in time. In other aspects, the creating comprises creating the plurality of kernel regression models for a temporal sequence of related points in time that ends with the single and current point in time.

In some examples, the measure of the center of the estimate distribution comprises an average. In other examples, the measure of the center of the estimate distribution comprises a median. In other aspects, the measure of the estimate distribution width comprises a standard deviation. In some other examples, at least one of the plurality of models are selectively eliminated based upon a predetermined criteria.

In others of these embodiments, an apparatus for obtaining estimates includes an interface and a processor. The interface includes an input and output, and the input is configured to receive sensed information representing physical parameters associated with the entity or process. The sensed information is collected into a current pattern or into a current sequence of patterns,

The processor is coupled to the interface. The processor is configured to compare the current pattern or current sequence of patterns to historical data in order to obtain a population of best matches. The processor is configured to create a plurality of kernel regression models based upon the population of best matches and generate at least one distribution of estimate values for a sensor of interest using the plurality of kernel regression models. The processor is further configured to analyze the at least one distribution of the estimate values for a sensor of interest to obtain a measure of the center of the at least one estimate distribution and a measure of an estimate distribution width of the at least one estimate distribution. The processor presents the measure of the center of the at least one estimate distribution and the measure of an estimate distribution width of the at least one estimate distribution at the output.

### BRIEF DESCRIPTION OF THE DRAWINGS

For a more complete understanding of the disclosure, reference should be made to the following detailed description and accompanying drawings wherein:

FIG. 1 comprises a block diagram of a system for obtaining estimates according to various embodiments of the present invention;

FIG. 2 comprises a graph showing different statistical aspects of estimated values according to various embodiments of the present invention;

FIG. 3 comprises a flowchart of an approach for obtaining estimates according to various embodiments of the present invention;

FIG. 4 comprises a block diagram of an apparatus for obtaining estimates according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

The present approaches utilize ensemble learning and randomized feature selection attributes that are the distinguishing characteristic of stochastic modeling methods like random forests and gradient boosting models. But, unlike these traditional ensemble learning algorithms which utilize weak learners such as decision trees, the present approaches utilize the comparatively strong learning algorithm of the localized kernel regression model.

Two forms of kernel regression modeling algorithms utilize the localized learning algorithm, and both of these modeling technologies can be used according to the present approaches. An example of the first form of these modeling algorithms, also known as Variable Similarity Based Modeling (VBM), is described in U.S. Pat. No. 7,403,869, which is incorporated herein by reference in its entirety. An example of the second form of kernel regression algorithms, also known as Sequential Similarity Based Modeling (SSM), is described in U.S. Pat. No. 8,602,853 and this is also incorporated herein by reference in its entirety.

In the localized learning algorithms utilized by the present approaches, the current state of the monitored system is compared to the states in a much larger reference array of learned states. A similarity operator or other pattern matching function is applied to provide a numeric score of the pattern overlap between the current state and each of the states in the reference array. A small set, for example 10, of the references states with the highest score are collected in a training matrix to create a model. The model is used to generate an estimate of the current state.

In the context of the VBM algorithm, a state is an observation vector, while in the context of SSM, a state is a sequence of temporally-related observation vectors. In much of the present disclosure, much of the discussion relates to the application of the present approaches utilizing the VBM algorithm. But without loss of generality, it should be understood that the present approaches equally apply to and can utilize the SSM algorithm.

Because the number of vectors in the reference array tends to be larger than the number of unique operating states of the system, only a small fraction of the reference vectors that are a good match to the current observation vector are selected. Furthermore, the reference vectors that produce the highest pattern matches tend to be those that have random fluctuations that are in agreement with the random fluctuations of the observation vector. This alignment of random elements in composite signals increases the tendency of the model to overfit the noise component of the data.

The ensemble kernel regression model based approaches described herein counteract the tendency of the localized learning algorithm to create models that overfit by randomly selecting training vectors from the larger population of reference vectors that are a good match to the observation vector. The random selection of reference vectors to create a regression model is performed numerous times, for instance, 50 times.

Each of the regression models generates an estimate vector. The collection of estimate vectors generated by the ensemble of kernel regression models is averaged to produce an estimate vector that is less colored by noise than any of the constituent vectors. The accuracy of the ensemble of models is provided by measures of variation in the distribution of estimate vectors, such as the standard deviation or the difference between the 5th and 95th percentile of the distributions. These statistics are calculated for each of the variables in the model.

Because the training vectors are randomly selected, it is possible that an ensemble model will perform poorly. In some aspects, a pruning algorithm is utilized to eliminate any poorly performing ensemble model. In one example, the pruning algorithm utilizes a statistic called the global similarity, and is described in U.S. Pat. No. 6,859,739, which is incorporated herein by reference in its entirety. Other types of pruning algorithms exist. In general, these algorithms provide a statistical measure of model quality or goodness of fit. Such statistical measures include measures as root-mean-squared error and the coefficient of determination (also known as the R squared statistic). The pruning algorithm applies the model quality measure to the output of each ensemble model (i.e., estimate vector), and eliminates any ensemble model whose quality is less than some predefined threshold value.

Since model estimates are derived from the mean response of a family of related models, ensemble kernel regression models provide a more robust estimate of system response than standard kernel regression models that create a single estimate for an observation vector, because the process and sensor noise that affects a single model is reduced by averaging across the ensemble. But what may be of greater benefit is that the variation across the ensemble of model outputs is a direct measure of the confidence of overall model response. Not only can ensemble kernel regression models provide estimates of the response of all model variables, but they can provide upper and lower confidence bounds on individual estimates.

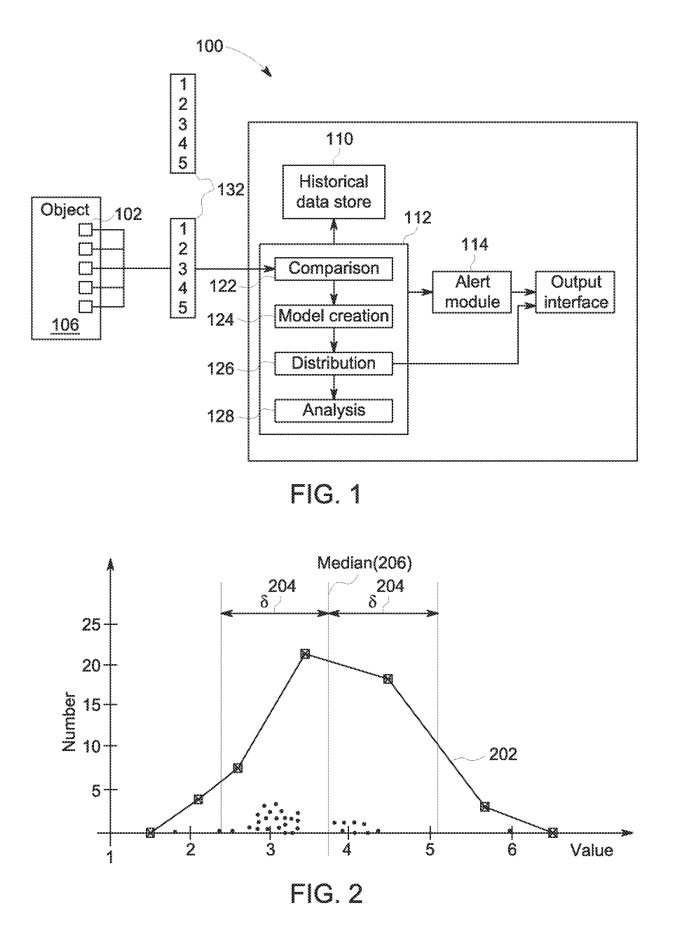

Referring to FIG. 1, an estimation system 100, which may be a VBM system or a SSM system incorporating time domain information can be embodied in a computer program in the form of one or more modules and executed on one or more computers and/or by one or more processors.

The computer or processor may have one or more memory storage devices, whether internal or external, to hold sensor data and/or the computer programs whether permanently or temporarily. In one form, a standalone computer runs a program dedicated to receiving sensor data from sensors on an instrumented machine, process or other object including a living being, measuring parameters (temperature, pressure, and so forth). The object being monitored, while not particularly limited, may be one or more wind turbines in a wind farm, equipment related to an undersea oil well, one or more machines in an industrial plant, one or more vehicles, or particular machines on the vehicles such as jet engines to name a few examples. The sensor data may be transmitted through wires or wirelessly over a computer network or the internet, for example, to the computer or database performing the data collection. One computer or processor with one or more processors may perform all of the monitoring tasks for all of the modules, or each task or module may have its own computer or processor performing the module. Thus, it will be understood that processing may take place at a single location or the processing may take place at many different locations all connected by a wired or wireless network.

The system 100 receives data or signals from sensors 102 on an object 106 being monitored as described above. This data is arranged into one or more input vectors 132 for use by the system 100. Herein, the terms input, actual, and current are used interchangeably, and the terms vector, snapshot, and observation are used interchangeably. The input vector (or actual snapshot for example) represents the operational state of the machine being monitored at a single moment in time. In one example, one input vector is received (VBM). In another example, a sequence of temporally-related vectors is received (SSM). In one example, several sensor values are obtained very frequently while other sensor values are obtained infrequently. In other words, for a current point in time some sensor values are definitely known, while others are not known.

It is desired by a user to obtain an estimate of the infrequent (unknown) sensor values from one or more sensors of interest at the current point in time. It may also be desired to obtain estimates for the infrequent (unknown) sensor values from one or more sensors of interest at future points in time. For both of these results, it is desired to know the statistical uncertainty of the estimated values. Using the approaches described herein, this information can be ascertained and presented to a user at the output interface 116.

The input vector 132 may include calculated data that may or may not have been calculated based on the sensor data (or raw data). This may include, for example, an average pressure or a change in pressure, temperatures, wind speeds, flow rates, and any other type of calculated parameter. The input vector 132 may also have values representing other variables not represented by the sensors on the object 106. This may be, for example, the average ambient temperature for the day of the year the sensor data is received, and so forth.

The system includes a historical data store 110, an estimation module 112, an alert module 114, and an output interface 116. The estimation module 112 includes a comparison module 122, a model creation module 124, a distribution module 126, and an analysis module 128. It will be appreciated that any of the components may be implemented using any combination of hardware and/or computer software. For example, any of the components may be implement using computer instructions that are executed on a processing device.

In operation, data is received by the estimation module 112. The estimation module provides an estimate and an accuracy range for the estimate. The estimate and accuracy range may be for a current point in time (if VBM approaches are used), or for one or more future points in time (if SSM approaches are used). The alert module 114 may send alerts to users when certain predetermined criteria are met. Alerts along with estimates (and distributions/uncertainties of the estimates) can be displayed at the output interface 116. The output interface 116 may be any type of interface (e.g., display screen, touch screen) on any type of device (e.g., computer, tablet, cellular phone, display).

Turning now to the specific operation and structure of the estimation module 112, as mentioned and in one aspect four modules 122, 124, 126 and 128 are utilized to perform its functionality. It will be appreciated that the modules 122, 124, 126, and 128 may be implemented by any combination of hardware and software. In one example, the modules 122, 124, 126, and 128 are implemented using computer instructions executed on a processing device such as a microprocessor.

The comparison module 122 compares the current pattern or current sequence of patterns (obtained from the received input vectors) to historical data from the historical data store to obtain a population of best matches. The best matches may be those that satisfy a predetermined criterion. For example, vectors that have similarity values above a certain numeric threshold may be selected.

The model creation module 124 creates a plurality of kernel regression models based upon the population of best matches. The following equations and discussion are for similarity-based models (SBMs). SBMs are one form of kernel regression modeling. It will be appreciated that other forms of kernel regression models can also be utilized.

The models referred to herein refer to mathematical relationships that can be implemented or stored as data structures. The estimate is made from these models and the estimate is made independent of the origin of the data, according to the following equation, where the estimate is normalized by dividing by the sum of the “weights” created from the similarity operator:

$${x}_{est} = \frac{D \cdot {( {D}^{T} ⊗ D )}^{- 1} \cdot ( {D}^{T} ⊗ {x}_{new} )}{Σ ( {( {D}^{T} ⊗ D )}^{- 1} \cdot ( {D}^{T} ⊗ {x}_{new} ) )} \qquad ( 1 )$$

In the inferential form of similarity-based modeling, the inferred parameters vector yₑₛₜ is estimated from the learned observations and the input according to:

yₑₛₜ=Dₒᵤₜ·(Dᵢₙ^{T} [symbol] Dᵢₙ)⁻¹·(Dᵢₙ^{T} [symbol] xᵢₙ) (2)

where Dᵢₙ has the same number of rows as actual sensor values (or parameters) in xᵢₙ, and Dₒᵤₜ has the same number of rows as the total number of parameters including the inferred parameters or sensors.

In one form, the matrix of learned exemplars Dₐ can be understood as an aggregate matrix containing both the rows that map to the sensor values in the input vector xᵢₙ and rows that map to various sensors:

$${D}_{a} = [ \frac{{D}_{in}}{{D}_{out}} ] \qquad ( 3 )$$

Normalizing as before using the sum of the weights:

$${y}_{est} = \frac{{D}_{out} \cdot {( {D}_{in}^{T} ⊗ {D}_{in} )}^{- 1} \cdot ( {D}_{in}^{T} ⊗ {x}_{in} )}{Σ ( {( {D}_{in}^{T} ⊗ {D}_{in} )}^{- 1} \cdot ( {D}_{in}^{T} ⊗ {x}_{in} ) )} \qquad ( 4 )$$

It should be noted that by replacing Dₒᵤₜ with the full matrix of leaned exemplars Dₐ, similarity-based modeling can simultaneously calculate estimates for the input sensors (auto associative form) and the inferred sensors (inferential form):

$$[ \frac{{x}_{est}}{{y}_{est}} ] = \frac{{D}_{a} \cdot {( {D}_{in}^{T} ⊗ {D}_{in} )}^{- 1} \cdot ( {D}_{in}^{T} ⊗ {x}_{in} )}{Σ ( {( {D}_{in}^{T} ⊗ {D}_{in} )}^{- 1} \cdot ( {D}_{in}^{T} ⊗ {x}_{in} ) )} \qquad ( 5 )$$

It will be appreciated that when VBM approaches are used, Xᵢₙ is a single vector and Dₐ is a two dimensional array. For SSM approaches, Xᵢₙ is an array of time sequence vectors, and Dₐ is a collection of time sequenced arrays. The models so-created are used to generate estimate values. For instance, an estimate for a requested sensor may be obtained for the current point in time (when VBM approaches are used) or for future points in time (when SSM approaches are used).

The model creation module 124 may also utilize a pruning algorithm to eliminate any poorly performing ensemble model. The pruning algorithm in one aspect utilizes a statistic called the global similarity, which is described in U.S. Pat. No. 6,859,739 already incorporated herein by reference in its entirety.

The distribution creation module 126 generates at least one distribution of requested sensor values using the plurality of kernel regression models. Turning now briefly to FIG. 2, an example of the statistical information utilized by the present approaches is described. The x-axis has various points representing estimate values for a sensor of interest. Each point is a separate estimate from a separate ensemble model. The y-axis represents the number of points over a given interval (on the x-axis). It can be seen that a plot 202 of the frequency or number of points in a given x-axis interval is obtained and in one aspect is a Gaussian-like distribution. The plot 202 has a median 206 and a standard deviation 204. Two standard deviations represent, for example, 90% of all the estimates. Thus, the median estimate is approximately 3.8+/−1 in one example.

The analysis module 128 analyzes the distribution of the requested sensor values to obtain a measure of the center of the at least one distribution and a measure of the width of the at least one distribution. As mentioned, the distribution creation module 126 calculates a distribution of estimate points using the models obtained by the model creation module 124 to obtain the points. In one example, and utilizing VBM approaches, various models are utilized to achieve estimate points. Each estimate point may represent an estimate of a sensor value that is desired by a user. The analysis module 128 may calculate the average (i.e., the sum of all the estimates divided by the number of estimates), the median, and the standard deviation, to mention a few examples. This information may be provided to the user via the output interface 116.

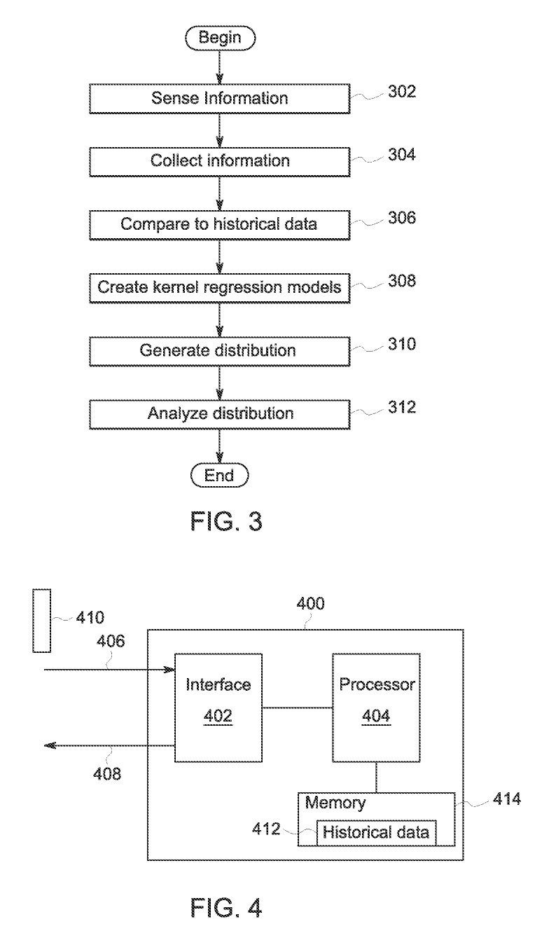

Referring now to FIG. 3, one approach for obtaining estimates is described. At step 302, information representing physical parameters associated with the entity or process is sensed.

At step 304, the sensed information is collected into a current pattern or into a current sequence of patterns. At step 306, the current pattern or current sequence of patterns is compared to historical data in order to obtain a population of best matches.

At step 308, a plurality of kernel regression models is created based upon the population of best matches. At step 310, at least one distribution of estimate values is generated for a sensor of interest using the plurality of kernel regression models. At step 312, the at least one distribution of the estimate values is analyzed for a sensor of interest to obtain a measure of the center of the at least one estimate distribution and a measure of an estimate distribution width of the at least one estimate distribution.

Referring now to FIG. 4, an apparatus 400 for obtaining estimates includes an interface 402 and a processor 404. The interface 402 includes an input 406 and output 408, and the input 406 is configured to receive sensed information representing physical parameters associated with the entity or process. The sensed information is collected into a current pattern or into a current sequence of patterns 410,

The processor 404 is coupled to the interface 402. The processor 404 is configured to compare the current pattern or current sequence of patterns 410 to historical data 412 in a memory 414 in order to obtain a population of best matches. By “best” matches and as used herein, it is meant matches that satisfy or exceed a given criteria, standard, expectation, or guideline. The exact criteria, standard, expectation, or guideline can be adjusted to suit the needs of a particular user or system.

The processor 404 is configured to create a plurality of kernel regression models based upon the population of best matches and generate at least one distribution of estimate values for a sensor of interest using the plurality of kernel regression models.

The processor 404 is further configured to analyze the at least one distribution of the estimate values for a sensor of interest to obtain a measure of the center of the at least one estimate distribution and a measure of an estimate distribution width of the at least one estimate distribution. The processor 404 presents the measure of the center of the at least one estimate distribution and the measure of an estimate distribution width of the at least one estimate distribution at the output 408.

One example of an application of the present approaches that provides a commercial advantage over existing approaches concerns pump-assisted oil and gas extraction. Downhole sensors in oil and gas wells and on electrical-submersible pumps provide continuous measurements of parameters such as reservoir temperature, reservoir pressure, and pump speed, but provide for none of the key well performance parameters used to determine the volume of oil and gas extracted. Key performance parameters such as volumetric flow rate and water-cut (i.e., ratio of water produced compared to the volume of total liquids produced from an oil well) are measured at irregular intervals (at best) during well tests. By creating ensemble kernel regression models of continuous sensor signals and intermittent key performance signals, the volumetric flow rate and water-cut parameters can be estimated with associated confidence bands when well tests are not being performed (for a current time)

It will be appreciated that the present approaches randomize the selection of model training vectors. That is, for a given set of model sensors, various observation vectors containing sensor values are obtained. However, in other examples, the features used (e.g., the sensors used) may be randomized. That is, the sensors included as variables in a particular ensemble model are randomly selected. For instance, one ensemble model may utilize data from a first and second sensor. In a second ensemble model, data from another sensor grouping (a third and fourth sensor) may be used. In a third ensemble model, data from a third sensor grouping may be used (e.g., the first sensor and the third sensor).

As mentioned, the present approaches infer current missing measurements using the VBM approach. In the present example, this may be the current value volumetric flow with a +/− range. In other approaches, future measurements can be obtained according to SSM models. For example, the volumetric flow at two and three days in the future may be estimated with +/− range.

In another application, the present approaches may be applied to wind turbines organized in a wind farm to obtain predictions of the output power provided by individual turbines in the wind farm and/or the entire wind farm. In these regards, historical wind data from various turbines in the farm may be stored and used to create the models described herein. According to the present approaches and on a given day, wind speed or other sensor readings may be taken at certain times from certain turbines or points in the wind farm (e.g., from all sensors at 9:00 am and 10:00 am). Using SSM modeling with the present approaches, the multiple models are generated and these are used to generate an estimate of the power output of a particular turbine and/or a power output of the entire wind farm may be obtained for a given time in the future with a statistical tolerance (e.g., 11:00 am the same day the wind farm will be producing 99 MW +/−9 MW of power) or for a future day along with a statistical tolerance (e.g., tomorrow at 11:00 am the wind farm will be producing 101 MW +/−10 MW of power).

It will be appreciated that these are only two examples of applications where the present approaches can be employed and utilized. Other examples are possible.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method of estimating current or future behavior of an entity or process, the method comprising:
sensing information representing physical parameters associated with the entity or process;
collecting the sensed information into a current pattern or into a current sequence of patterns;
comparing the current pattern or current sequence of patterns to historical data in order to obtain a population of best matches;
creating a plurality of kernel regression models based upon the population of best matches;
generating at least one distribution of estimate values for a sensor of interest using the plurality of kernel regression models;
analyzing the at least one distribution of the estimate values for a sensor of interest to obtain a measure of the center of the at least one estimate distribution and a measure of an estimate distribution width of the at least one estimate distribution.

2. The method of claim 1, wherein the creating comprises creating the plurality of kernel regression models at a single and current point in time

3. The method of claim 1, wherein the creating comprises creating the plurality of kernel regression models for a temporal sequence of related points in time that ends with the single and current point in time.

4. The method of claim 1, wherein the measure of the center of the at least one estimate distribution comprises an average.

5. The method of claim 1, wherein the measure of the center of the at least one estimate distribution comprises a median.

6. The method of claim 1, wherein the measure of the estimate distribution width comprises a standard deviation.

7. The method of claim 1, further comprising selectively eliminating at least one of the plurality of models based upon a predetermined criteria.

8. An apparatus for obtaining estimates, the apparatus comprising:
an interface with an input and output, the input configured to receive sensed information representing physical parameters associated with the entity or process, the sensed information being collected into a current pattern or into a current sequence of patterns,
a processor coupled to the interface, the processor configured to compare the current pattern or current sequence of patterns to historical data in order to obtain a population of best matches, the processor configured to create a plurality of kernel regression models based upon the population of best matches and generate at least one distribution of estimate values for a sensor of interest using the plurality of kernel regression models, the processor further configured to analyze the at least one distribution of the estimate values for a sensor of interest to obtain a measure of the center of the at least one estimate distribution and a measure of an estimate distribution width of the at least one estimate distribution and present the measure of the center of the at least one estimate distribution and the measure of an estimate distribution width of the at least one estimate distribution at the output.

9. The apparatus of claim 8, wherein the plurality of kernel regression models are created at a single and current point in time

10. The apparatus of claim 8, wherein the plurality of kernel regression models are created for a temporal sequence of related points in time that ends with the single and current point in time.

11. The apparatus of claim 8, wherein the measure of the center of the at least one estimate distribution comprises an average.

12. The apparatus of claim 8, wherein the measure of the center of the at least one estimate distribution comprises a median.

13. The apparatus of claim 8, wherein the measure of the estimate distribution width comprises a standard deviation.

14. The apparatus of claim 8, wherein the processor is configured to selectively eliminate at least one of the plurality of models based upon a predetermined criteria.
